(19) United States
(12) Patent Application Publication
(10) Pub. No.: US 2024/0364661 A1
(43) Pub. Date: Oct. 31, 2024

(54) NETWORK MANAGEMENT DEVICE AND METHOD

(71) Applicant: INDUSTRIAL TECHNOLOGY RESEARCH INSTITUTE, HSINCHU (TW)

(72) Inventors: Che-Hao LIU, Taichung City (TW); Chuan-Yu CHO, Hsinchu City (TW); Yi-Ping LUO, Taoyuan City (TW); Chen Yi HO, Taoyuan City (TW)

(21) Appl. No.: 18/644,066

(22) Filed: Apr. 23, 2024

(30) Foreign Application Priority Data
Apr. 26, 2023 (TW) 112115527

(51) Int. Cl. H04L 9/40

(52) U.S. Cl. CPC H04L 63/0263

(57) ABSTRACT

A network management device and method are provided. In response to at least one electronic device transmitting a plurality of network packets, the network management device retrieves a plurality of network packet information corresponding to the network packets. The network management device determines a plurality of first packet features corresponding to the at least one electronic device based on the network packet information. The network management device generates at least one first candidate rule corresponding to the at least one electronic device based on the first packet features. The network management device manages the network packets transmitted by the at least one electronic device on the network based on the at least one first candidate rule.

### BACKGROUND

### Field of Invention

The present invention relates to a network management device and method. More particularly, the present invention relates to an unattended automated network management device and method.

### Description of Related Art

In recent years, network-related application services have become more and more diverse, and people pay more attention to the security of network information.

However, because general network management personnel may lack relevant information security background, network architecture, network management and other knowledge, the equipment cannot obtain appropriate network information security protection. In addition, due to the wide variety of current devices and applications, even professional network managers may not be able to fully understand individual network behaviors and provide correct network management.

In addition, since the intrusion detection systems (IDS/IPS) in the existing technology all adopt the form of blacklist rules, they will only block malicious attack network behaviors when they detect them. Therefore, when a new type of malicious attack occurs and its characteristics are not recorded and analyzed or updated immediately, the network management mechanism in the existing technology is still unable to effectively block the attack.

Therefore, if network behaviors can be automatically collected and analyzed, and then whitelist firewall rules can be formulated, so that manual supervision is not required at all (i.e., no human intervention is required), more comprehensive network security protection can be implemented for devices in the field to eliminate additional costs of the labor cost of hiring relevant security personnel and the problem of network breaches caused by improper rule formulation.

Accordingly, there is an urgent need for an automated network management technology that can achieve unattended operation.

### SUMMARY

An objective of the present disclosure is to provide a network management device. The network management device comprises a transceiver interface and a processor, and the processor is electrically connected to the transceiver interface. The transceiver interface is communicatively connected to at least one electronic device, and the at least one electronic device transmits a plurality of network packets through a network. In response to the at least one electronic device transmitting the plurality of network packets, the processor retrieves a plurality of network packet information corresponding to the plurality of network packets. The processor determines a plurality of first packet features corresponding to the at least one electronic device based on the plurality of network packet information. The processor generates at least one first candidate rule corresponding to the at least one electronic device based on the plurality of first packet features. The processor manages the plurality of network packets transmitted by the at least one electronic device on the network based on the at least one first candidate rule.

Another objective of the present disclosure is to provide a network management method, which is adapted for use in a network management device. The network management method comprises the following steps: determining, based on a plurality of network packet information corresponding to a plurality of network packets transmitted by at least one electronic device, a plurality of first packet features corresponding to the at least one electronic device; generating at least one first candidate rule corresponding to the at least one electronic device based on the plurality of first packet features; and managing the plurality of network packets transmitted by the at least one electronic device on a network based on the at least one first candidate rule.

According to the above descriptions, the network management technology (at least including the device and the method) provided by the present disclosure determines a plurality of first packets features corresponding to at least one electronic device by retrieving a plurality of network packet information corresponding to a plurality of network packets transmitted by the at least one electronic device, and generates at least one first candidate rule corresponding to the at least one electronic device based on the plurality of first packet features. Accordingly, the network management technology provided by the present disclosure can manage the plurality of network packets transmitted by the at least one electronic device on a network based on the at least one first candidate rule. The network management technology provided by the present disclosure can automatically collect and analyze network behaviors, so it can generate management rules (e.g., whitelist of the network firewall) for fixed network behaviors of individual electronic devices (e.g., host device or application), and automatically apply the rules to the firewall to enable network protection of the firewall. Therefore, the network management technology provided by the present disclosure solves the shortcomings of the conventional technology that require human intervention to set up and formulate rules, or that network administrators cannot fully understand the network behavior of individual devices and cannot provide correct network management.

The detailed technology and preferred embodiments implemented for the subject disclosure are described in the following paragraphs accompanying the appended drawings for people skilled in this field to well appreciate the features of the claimed invention.

### BRIEF DESCRIPTION OF THE DRAWINGS

FIG. 1 is a schematic view depicting applicable scenarios of the network management device of the first embodiment;

FIG. 2 is a schematic view depicting applicable scenarios of the network management device of some embodiments;

FIG. 3 is a schematic view depicting the structure of the network management device of some embodiments;

FIG. 4 is a schematic view depicting the operations of the network management device of some embodiments;

FIG. 5 is a schematic view depicting an example of the network packet of some embodiments; and

FIG. 6 is a partial flowchart depicting a network management method of the second embodiment.

### DETAILED DESCRIPTION

In the following description, a network management device and method according to the present disclosure will be explained with reference to embodiments thereof. However, these embodiments are not intended to limit the present disclosure to any environment, applications, or implementations described in these embodiments. Therefore, description of these embodiments is only for purpose of illustration rather than to limit the present disclosure. It shall be appreciated that, in the following embodiments and the attached drawings, elements unrelated to the present disclosure are omitted from depiction. In addition, dimensions of individual elements and dimensional relationships among individual elements in the attached drawings are provided only for illustration but not to limit the scope of the present disclosure.

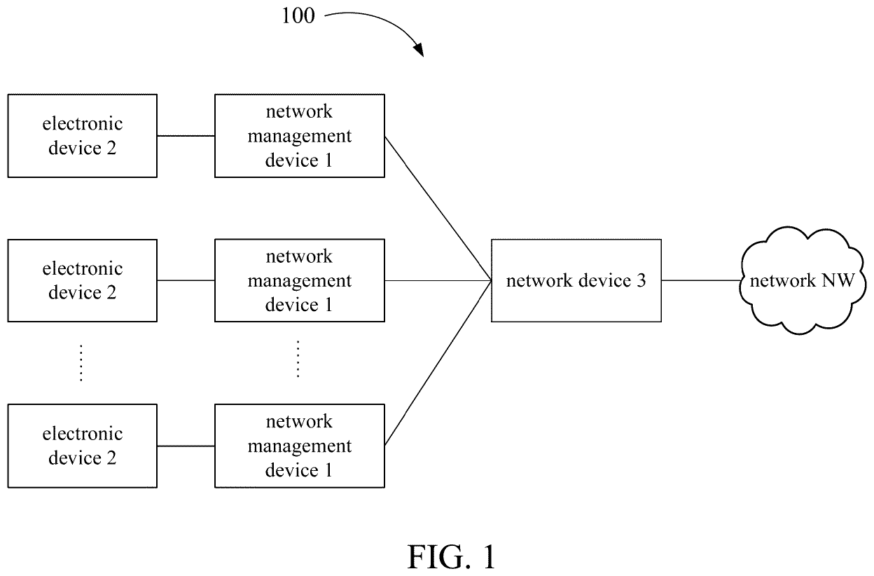

First, the applicable scenario of the present embodiment will be described, and its schematic diagram 100 is depicted in FIG. 1. As shown in FIG. 1, in some embodiments of the present disclosure, the network system of the present disclosure may comprise a plurality of electronic devices 2 and a plurality of network management devices 1, and the network management device 1 and the electronic device 2 have one-to-one connection relationship (e.g., connection through a wired communication or a wireless communication). It shall be appreciated that the electronic device 2 can be connected to the network NW (e.g., the Internet and the local area network) through the network device 3 (e.g., a router device), and the electronic device 2 can transmit the plurality of network packets through the network NW.

For example, the application environment in FIG. 1 can be, for example, an operational technology (OT) field, a medical field, etc., and the network management device 1 can be used to protect, for example, a robotic arm, a Da Vinci operating table, etc. and other equipment.

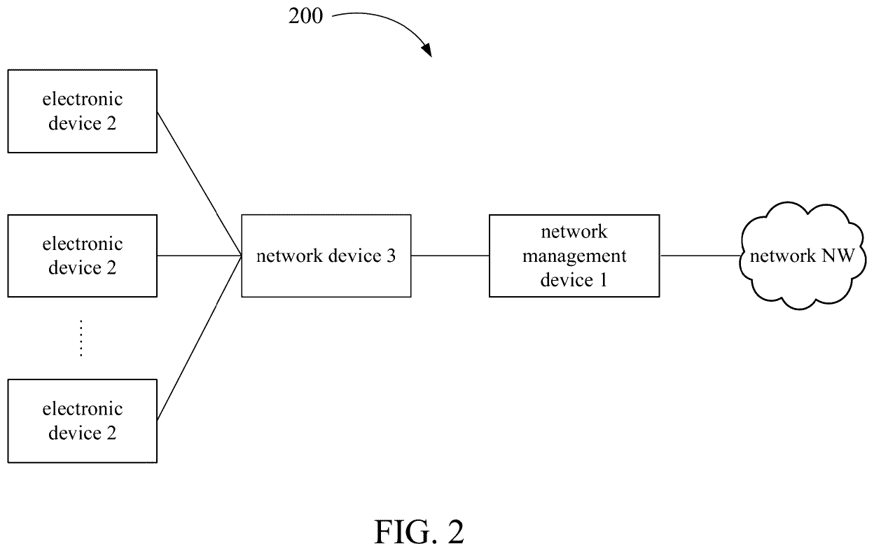

In addition, in some embodiments, the present disclosure can also uniformly manage multiple electronic devices 2 by one network management device 1. For ease of understanding, please refer to the scene diagram 200 in FIG. 2. As shown in FIG. 2, the network system of the present disclosure may comprise a plurality of electronic devices 2 and a network management device 1. The network device 3 has a connection relationship with the plurality of electronic devices 2 (e.g., connection through a wired communication or a wireless communication), the network device 3 has a connection relationship with the network management device 1 (e.g., connection through a wired communication or a wireless communication), and the plurality of electronic devices 2 are connected to the network device 3 through the Network NW. In addition, in some embodiments, the network device 3 and the network management device 1 can also exchange positions.

For example, the application environment in FIG. 2 can be used to perform the isolating and protecting operations for, for example, the fields of micro-network segments.

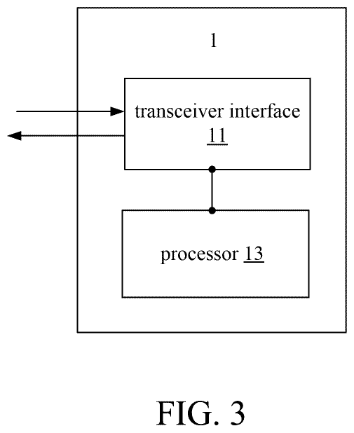

Next, the component structure of the network management device in the present embodiment is explained, and the schematic diagram is depicted in FIG. 3. As shown in FIG. 3, in the first embodiment of the present disclosure, the network management device 1 comprises a transceiver interface 11 and a processor 13. The processor 13 is electrically connected to the transceiver interface 11. In some embodiments, the network management device 1 further comprises a storage (not shown).

It shall be appreciated that the transceiver interface 11 is an interface capable of receiving and transmitting data or other interfaces capable of receiving and transmitting data and known to those of ordinary skill in the art. The transceiver interface can receive data from sources such as external apparatuses, external web pages, external applications, and so on. The processor 13 may be any of various processors, Central Processing Units (CPUs), microprocessors, digital signal processors or other computing apparatuses known to those of ordinary skill in the art. The storage may be a memory, a Universal Serial Bus (USB) disk, a hard disk, a Compact Disk (CD), a mobile disk, or any other storage medium or circuit known to those of ordinary skill in the art and having the same functionality.

For ease of understanding, the following paragraphs will take a network management device 1 and an electronic device 2 (hereinafter referred to as: the at least one electronic device 2) as an example. Those with ordinary knowledge in the art should be able to understand the implementations with different numbers of connections based on the descriptions of the present disclosure, so no further details are given here.

First, in the present embodiment, when the at least one electronic device 2 transmits a network packet (i.e., including a two-way operation of transmitting or receiving), the processor 13 may retrieve the network packet information of the network packet. Specifically, in response to the at least one electronic device 2 transmitting the plurality of network packets, the processor 13 retrieves a plurality of network packet information corresponding to the plurality of network packets.

Specifically, each of the plurality of network packet information comprises at least one of a media access control address, a packet time, a communication protocol, a source internet protocol, a source port, a destination Internet protocol, a destination port, a packet size, a packet content or a combination thereof.

In some embodiments, the processor 13 may further retrieve the plurality of network packet information corresponding to the plurality of network packets by executing command tools (e.g., tcpdump and tshark).

Next, the processor 13 determines a plurality of first packet features corresponding to the at least one electronic device 2 based on the plurality of network packet information.

It shall be appreciated that the processor 13 can determine the first packet features of at least one electronic device 2 through different analysis conditions.

For example, in some embodiments, the processor 13 may compare the plurality of network packet information of the plurality of network packets (e.g., the network packets with the same communication protocol, source Internet protocol, and destination Internet protocol) to calculate an occurrence frequency corresponding to the plurality of network packets (or the interval transmission time between the network packet and the network packet). Then, the processor 13 determines the plurality of first packet features corresponding to the at least one electronic device 2 based on the occurrence frequency corresponding to the plurality of network packets (e.g., some network packets with the same communication protocol, source Internet protocol, and destination Internet protocol will appear every 5 seconds).

In some embodiments, the processor 13 may further summarize the packet features corresponding to different time periods based on analyzing the packet time of each of the plurality of network packets. For example, the processor 13 may compare the plurality of network packet information of the plurality of network packets to calculate an occurrence frequency and a packet time corresponding to the plurality of network packets. Next, the processor 13 determines the plurality of first packet features corresponding to the at least one electronic device 2 based on the occurrence frequency and the packet time corresponding to the plurality of network packets (e.g., some network packets with the same communication protocol, source Internet protocol, and destination Internet protocol will be transmitted at a fixed time and with a fixed frequency).

In some embodiments, the processor 13 may further determine the corresponding packet features based on analyzing the packet size of each network packet. For example, the processor 13 may compare the plurality of network packet information of the plurality of network packets to calculate an occurrence frequency, a packet time, and a packet size corresponding to the plurality of network packets. Then, the processor 13 determines the plurality of first packet features corresponding to the at least one electronic device 2 based on the occurrence frequency, the packet time, and the packet size corresponding to the plurality of network packets (e.g., some network packets with the same communication protocol, source Internet protocol, and destination Internet protocol will be transmitted at a fixed time period, with a fixed frequency, and with a fixed packet size).

It shall be appreciated that since the at least one electronic device 2 may simultaneously transmit multiple groups of network packets in a time interval with different communication protocols, source Internet protocols, destination Internet protocols, etc., and thus the processor 13 may generate multiple sets of different packet features corresponding to different types/combinations of network packets.

Next, the processor 13 generates at least one first candidate rule corresponding to the at least one electronic device 2 based on the plurality of first packet features. It shall be appreciated that each the at least one first candidate rule corresponds to a first behavioral feature of the at least one electronic device 2 (i.e., a fixed behavioral feature of the at least one electronic device 2), and the first behavioral feature is composed of the first packet features.

For example, the processor 13 may select some of the packet features from the plurality of packet features corresponding to certain specific network packets as management conditions, and integrate them into a set of candidate rules.

Finally, the processor 13 manages the plurality of network packets transmitted by the at least one electronic device 2 on the network based on the at least one first candidate rule.

For example, in the application environment of a robot arm in an industrial control field, the candidate rule generated by the processor 13 may be, for example, the behavioral feature corresponding to “the network packets transmitted every 5 minutes from the period of 9 am to 6 pm from Monday to Friday”. Accordingly, the processor 13 can allow the robot arm in an industrial control field to operate the transmitted network packet every 5 minutes at the fixed period of 9 am to 6 pm from Monday to Friday (i.e., the main console sends the network packets that dispatch robot arm instructions or the network packets that are returned by the robot arm to the central console).

In some embodiments, the processor 13 may select a part of the at least one first candidate rule as application rules that are actually used for management by the network management device 1. Specifically, the processor 13 calculates a rule weight corresponding to each of the at least one first candidate rule (e.g., the number of occurrences and high/low frequency corresponding to the network packets). Then, the processor 13 determines at least one application rule from the at least one first candidate rule based on the rule weights (e.g., the top 80% candidate rules). Finally, the processor 13 manages the plurality of network packets transmitted by the at least one electronic device 2 on the network based on the at least one application rule.

In some embodiments, the processor 13 may only allow the network packets that conform to the rules to be transmitted by setting a mechanism of the whitelist (e.g., a network firewall whitelist). Otherwise, the processor 13 may block the network packets that do not conform to the rules to perform a transmission operation (i.e., includes a two-way operation of transmitting and receiving by the at least one electronic device 2). Specifically, the processor 13 determines whether a network packet to be transmitted conforms to the at least one application rule. Next, in response to the network packet to be transmitted conforming to the at least one application rule, the processor 13 allows the at least one electronic device 2 to transmit the network packet to be transmitted on the network.

In some embodiments, in order to more accurately manage the network packets transmitted by the electronic device on the network, the processor 13 may further analyze the firewall log of the network device (e.g., a router device) and generate the candidate rules. Specifically, the processor 13 receives a firewall log. Then, the processor 13 retrieves a plurality of second packet features corresponding to the at least one electronic device 2 from the firewall log. Next, the processor 13 generates at least one second candidate rule corresponding to the at least one electronic device 2 based on the plurality of second packet features. Finally, the processor 13 manages the plurality of network packets transmitted by the at least one electronic device 2 on the network based on the at least one first candidate rule and the at least one second candidate rule.

In some embodiments, the processor 13 may further collect firewall logs of network devices by executing command tools (such as rsyslog and syslog-ng).

Specifically, the firewall log may include at least one of firewall operation information (e.g., whether the generated rules can operate normally), application program interface interaction records, rule matching records, or a combination thereof.

For example, the processor 13 may analyze which network packets are allowed to pass or are blocked by retrieving past historical rule matching records in the firewall log, retrieves a plurality of packet features corresponding to the at least one electronic device 2, and generates candidate rules corresponding to the firewall log.

It shall be appreciated that the processor 13 receives the firewall log from a network device (e.g., the network device 3 in FIG. 2), the at least one electronic device 2 is communicatively connected to the network device 3, and the at least one electronic device 2 transmits the plurality network packets through the network device. It shall be appreciated that since the information recorded by the network device 3 includes information on the external network and the local network, the processor 13 can more accurately generate candidate rules based on the contents of the firewall log.

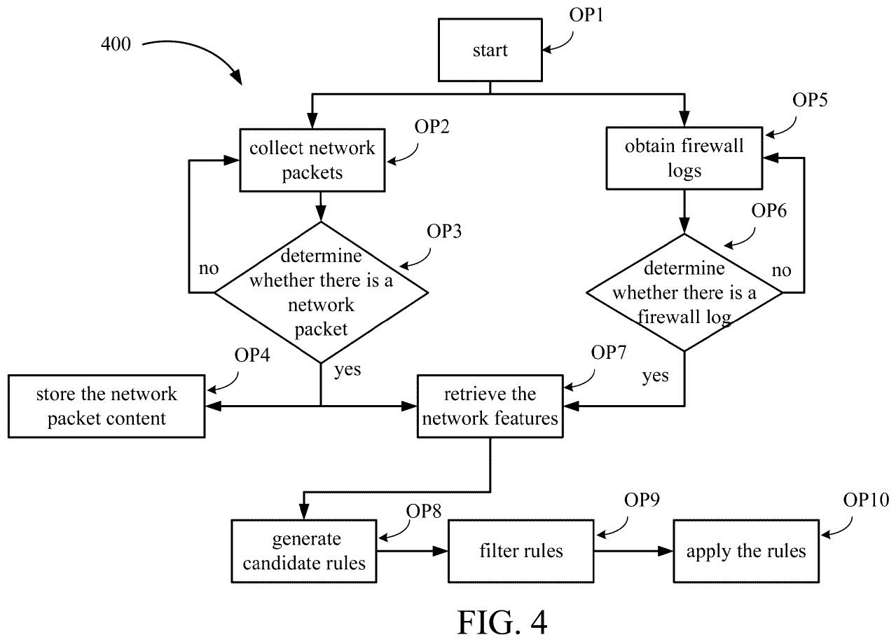

To facilitate understanding of the operation process of some embodiments of the present disclosure, please refer to the flow diagram 400 in FIG. 4. First, the processor 13 starts to execute the operation OP1 of the network management. Next, the processor 13 executes the operation OP2 to collect network packets and executes the operation OP5 to obtain firewall logs. Then, the processor 13 executes the operation OP3 to determine whether there is a network packet. When the determination of the operation OP3 is yes, the processor 13 executes the operation OP4 to store the network packet content (e.g., the network packet information) and executes the operation OP7 to retrieve the network features. When the determination of the operation OP3 is no, the processor 13 executes the operation OP2 to continuously collect network packets (i.e., continuously monitors whether the electronic device transmits network packets).

In addition, the processor 13 executes the operation OP6 to determine whether there is a firewall log. When the determination of the operation OP6 is yes, the processor 13 executes the operation OP7 to retrieve the network features. When the determination of the operation OP6 is no, the processor 13 13 executes the OP5 to continuously retrieve firewall logs.

Next, the processor 13 executes the operation OP8 to generate candidate rules. Next, the processor 13 executes the operation OP9 to filter rules from the candidate rules. Finally, the processor 13 executes the operation OP10 to apply the rules to perform management operations of the network packets in the network management device 1.

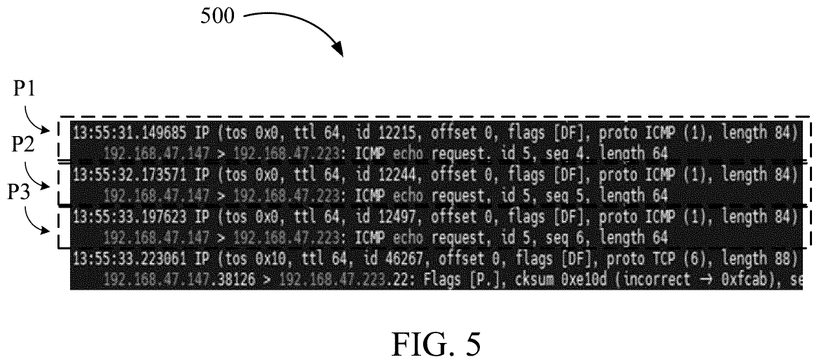

For ease of understanding, an actual example is used for explanation. Please refer to the network packet example schematic diagram 500 in FIG. 5. In the present example, the processor 13 first retrieves the information of the network packet P1. The network packet information corresponding to the network packet P1 comprises the source IP “192.168.47.147”, the destination IP “192.168.47.223”, the communication protocol “ICMP”, the packet size “84 bytes” and the packet time “13:55:31”. Next, the processor 13 determines the time interval from the previous network packet. In the present example, since there is no other previous packet data, the first determination is ended.

Next, the processor 13 retrieves the second network packet P2. The network packet information corresponding to the network packet P2 comprises the source IP “192.168.47.147”, the destination IP “192.168.47.223”, and the communication protocol “ICMP”, the packet size “84 bytes”, and the packet time “13:55:32”. Next, the processor 13 determines the time interval from the previous network packet. Since the time of the previous network packet is “13:55:31”, the processor 13 determines that the time interval is 1 second. Since there is no other packet data, the processor 13 ends the present determination.

Next, the processor 13 retrieves the third network packet P3. The network packet information corresponding to the network packet P3 comprises the source IP “192.168.47.147”, the destination IP “192.168.47.223”, and the communication protocol “ICMP”, the packet size “84 bytes”, and the packet time “13:55:33”. Next, the processor 13 determines the time interval from the previous network packet. Since the time of the previous network packet is “13:55:32”, the processor 13 determines that the time interval is 1 second. By comparing the occurrence frequency, the processor 13 determines that the time interval of this type of network packets is 1 second (i.e., the time interval between the network packet P1 and the network packet P2 is 1 second, and the time interval between the network packet P2 and the network packet P3 is 1 second).

In the present example, the processor 13 may further dynamically adjust the comparison threshold to 3 (i.e., when the number of the network packets matching the comparison reaches the comparison threshold, the processor 13 may activate the management mechanism). Since the processor 13 may dynamically update the comparison threshold, it can detect behavioral features in real time and activate the management mechanism.

In addition, the processor 13 may further compare the occurrence time period of the network packets and determine that network packets of this type all appear in the interval of time “13:55”. In addition, the processor 13 may further compare the packet sizes of the network packets and determine that all network packets of this type have a packet size of “84 bytes”.

Accordingly, the rules generated by the processor 13 are to allow the transmission of the network packets corresponding to the source IP “192.168.47.147”, the destination IP “192.168.47.223”, the communication protocol “ICMP”, the packet size “84 bytes”, and the packet time “13:55”.

According to the above descriptions, the network management device 1 provided by the present disclosure determines a plurality of first packets features corresponding to at least one electronic device by retrieving a plurality of network packet information corresponding to a plurality of network packets transmitted by the at least one electronic device, and generates at least one first candidate rule corresponding to the at least one electronic device based on the plurality of first packet features. Accordingly, the network management device 1 provided by the present disclosure can manage the plurality of network packets transmitted by the at least one electronic device on a network based on the at least one first candidate rule. The network management device 1 provided by the present disclosure can automatically collect and analyze network behaviors, so it can generate management rules (e.g., whitelist of the network firewall) for fixed network behaviors of individual electronic devices (e.g., host device or application), and automatically apply the rules to the firewall to enable network protection of the firewall. Therefore, the network management device 1 provided by the present disclosure solves the shortcomings of the conventional technology that require human intervention to set up and formulate rules, or that network administrators cannot fully understand the network behavior of individual devices and cannot provide correct network management.

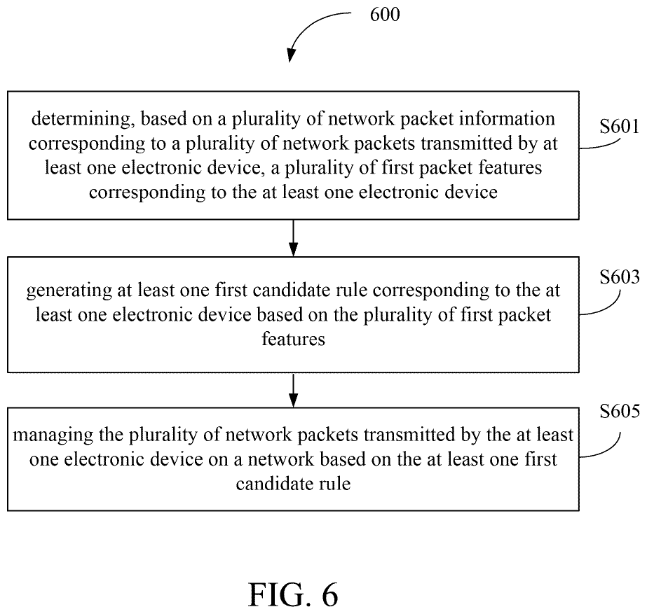

A second embodiment of the present disclosure is a network management method and a flowchart thereof is depicted in FIG. 6. The network management method 600 is adapted for a network management device (e.g., the network management device 1 of the first embodiment). The network management method 600 manages the network packets transmitted by at least one electronic device on a network through the steps S601 to S605.

In the step S601, based on a plurality of network packet information corresponding to a plurality of network packets transmitted by at least one electronic device, the network management device determines a plurality of first packet features corresponding to the at least one electronic device. Next, in the step S603, the network management device generates at least one first candidate rule corresponding to the at least one electronic device based on the plurality of first packet features. Finally, in the step S605, the network management device manages the plurality of network packets transmitted by the at least one electronic device on a network based on the at least one first candidate rule.

In some embodiments, wherein each of the plurality of network packet information comprises at least one of a media access control address, a packet time, a communication protocol, a source internet protocol, a source port, a destination Internet protocol, a destination port, a packet size, a packet content or a combination thereof.

In some embodiments, wherein the network management method 600 further comprises the following steps: comparing the plurality of network packet information of the network packets to calculate an occurrence frequency corresponding to the plurality of network packets; and determining the plurality of first packet features corresponding to the at least one electronic device based on the occurrence frequency corresponding to the plurality of network packets.

In some embodiments, wherein the network management method 600 further comprises the following steps: comparing the plurality of network packet information of the plurality of network packets to calculate an occurrence frequency and a packet time corresponding to the plurality of network packets; and determining the plurality of first packet features corresponding to the at least one electronic device based on the occurrence frequency and the packet time corresponding to the plurality of network packets.

In some embodiments, wherein the network management method 600 further comprises the following steps: comparing the plurality of network packet information of the plurality of network packets to calculate an occurrence frequency, a packet time, and a packet size corresponding to the plurality of network packets; and determining the plurality of first packet features corresponding to the at least one electronic device based on the occurrence frequency, the packet time, and the packet size corresponding to the plurality of network packets.

In some embodiments, wherein the network management method 600 further comprises the following steps: calculating a rule weight corresponding to each of the at least one first candidate rule; determining at least one application rule from the at least one first candidate rule based on the rule weights; and managing the plurality of network packets transmitted by the at least one electronic device on the network based on the at least one application rule.

In some embodiments, wherein the network management method 600 further comprises the following steps: determining whether a network packet to be transmitted conforms to the at least one application rule; and in response to the network packet to be transmitted conforming to the at least one application rule, allowing the at least one electronic device to transmit the network packet to be transmitted on the network.

In some embodiments, wherein the network management method 600 further comprises the following steps: receiving a firewall log; retrieving a plurality of second packet features corresponding to the at least one electronic device from the firewall log; generating at least one second candidate rule corresponding to the at least one electronic device based on the plurality of second packet features; and managing the plurality of network packets transmitted by the at least one electronic device on the network based on the at least one first candidate rule and the at least one second candidate rule.

In some embodiments, wherein the network management device receives the firewall log from a network device, the at least one electronic device is communicatively connected to the network device, and the at least one electronic device transmits the plurality of network packets through the network device.

In addition to the aforesaid steps, the second embodiment can also execute all the operations and steps of the network management device 1 set forth in the first embodiment, have the same functions, and deliver the same technical effects as the first embodiment. How the second embodiment executes these operations and steps, has the same functions, and delivers the same technical effects will be readily appreciated by those of ordinary skill in the art based on the explanation of the first embodiment. Therefore, the details will not be repeated herein.

It shall be appreciated that in the specification and the claims of the present disclosure, some words (e.g., the packet features, the candidate rule, etc.) are preceded by terms such as “first”, or “second”, and these terms of “first”, or “second” are only used to distinguish these different words. For example, the “first” packet features and the “second” packet features are only used to indicate the packet features used in different operations.

According to the above descriptions, the network management technology (at least including the device and the method) provided by the present disclosure determines a plurality of first packets features corresponding to at least one electronic device by retrieving a plurality of network packet information corresponding to a plurality of network packets transmitted by the at least one electronic device, and generates at least one first candidate rule corresponding to the at least one electronic device based on the plurality of first packet features. Accordingly, the network management technology provided by the present disclosure can manage the plurality of network packets transmitted by the at least one electronic device on a network based on the at least one first candidate rule. The network management technology provided by the present disclosure can automatically collect and analyze network behaviors, so it can generate management rules (e.g., whitelist of the network firewall) for fixed network behaviors of individual electronic devices (e.g., host device or application), and automatically apply the rules to the firewall to enable network protection of the firewall. Therefore, the network management technology provided by the present disclosure solves the shortcomings of the conventional technology that require human intervention to set up and formulate rules, or that network administrators cannot fully understand the network behavior of individual devices and cannot provide correct network management.

The above disclosure is related to the detailed technical contents and inventive features thereof. People skilled in this field may proceed with a variety of modifications and replacements based on the disclosures and suggestions of the disclosure as described without departing from the characteristics thereof. Nevertheless, although such modifications and replacements are not fully disclosed in the above descriptions, they have substantially been covered in the following claims as appended.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A network management device, comprising:
a transceiver interface, being communicatively connected to at least one electronic device, wherein the at least one electronic device transmits a plurality of network packets through a network; and
a processor, being electrically connected to the transceiver interface, and being configured to perform the following operations:
in response to the at least one electronic device transmitting the plurality of network packets, retrieving a plurality of network packet information corresponding to the plurality of network packets;
determining a plurality of first packet features corresponding to the at least one electronic device based on the plurality of network packet information;
generating at least one first candidate rule corresponding to the at least one electronic device based on the plurality of first packet features; and
managing the plurality of network packets transmitted by the at least one electronic device on the network based on the at least one first candidate rule.

2. The network management device of claim 1, wherein each of the plurality of network packet information comprises at least one of a media access control address, a packet time, a communication protocol, a source internet protocol, a source port, a destination Internet protocol, a destination port, a packet size, a packet content or a combination thereof.

3. The network management device of claim 1, wherein the operation of determining the plurality of first packet features corresponding to the at least one electronic device comprises the following operations:
comparing the plurality of network packet information of the plurality of network packets to calculate an occurrence frequency corresponding to the plurality of network packets; and
determining the plurality of first packet features corresponding to the at least one electronic device based on the occurrence frequency corresponding to the plurality of network packets.

4. The network management device of claim 1, wherein the operation of determining the plurality of first packet features corresponding to the at least one electronic device comprises the following operations:
comparing the plurality of network packet information of the plurality of network packets to calculate an occurrence frequency and a packet time corresponding to the plurality of network packets; and
determining the plurality of first packet features corresponding to the at least one electronic device based on the occurrence frequency and the packet time corresponding to the plurality of network packets.

5. The network management device of claim 1, wherein the operation of determining the plurality of first packet features corresponding to the at least one electronic device comprises the following operations:
comparing the plurality of network packet information of the plurality of network packets to calculate an occurrence frequency, a packet time, and a packet size corresponding to the plurality of network packets; and
determining the plurality of first packet features corresponding to the at least one electronic device based on the occurrence frequency, the packet time, and the packet size corresponding to the plurality of network packets.

6. The network management device of claim 1, wherein the processor further performs the following operations:
calculating a rule weight corresponding to each of the at least one first candidate rule;
determining at least one application rule from the at least one first candidate rule based on the rule weights; and
managing the plurality of network packets transmitted by the at least one electronic device on the network based on the at least one application rule.

7. The network management device of claim 6, wherein the operation of managing the plurality of network packets transmitted by the at least one electronic device on the network comprises the following operations:
determining whether a network packet to be transmitted conforms to the at least one application rule; and
in response to the network packet to be transmitted conforming to the at least one application rule, allowing the at least one electronic device to transmit the network packet to be transmitted on the network.

8. The network management device of claim 1, wherein the processor further performs the following operations:
receiving a firewall log;
retrieving a plurality of second packet features corresponding to the at least one electronic device from the firewall log;
generating at least one second candidate rule corresponding to the at least one electronic device based on the plurality of second packet features; and
managing the plurality of network packets transmitted by the at least one electronic device on the network based on the at least one first candidate rule and the at least one second candidate rule.

9. The network management device of claim 8, wherein the processor receives the firewall log from a network device, and the at least one electronic device is communicatively connected to the network device.

10. The network management device of claim 9, wherein the at least one electronic device transmits the plurality of network packets through the network device.

11. A network management method, being adapted for use in a network management device, wherein the network management method comprises the following steps:
determining, based on a plurality of network packet information corresponding to a plurality of network packets transmitted by at least one electronic device, a plurality of first packet features corresponding to the at least one electronic device;
generating at least one first candidate rule corresponding to the at least one electronic device based on the plurality of first packet features; and
managing the plurality of network packets transmitted by the at least one electronic device on a network based on the at least one first candidate rule.

12. The network management method of claim 11, wherein each of the plurality of network packet information comprises at least one of a media access control address, a packet time, a communication protocol, a source internet protocol, a source port, a destination Internet protocol, a destination port, a packet size, a packet content or a combination thereof.

13. The network management method of claim 11, wherein the step of determining the plurality of first packet features corresponding to the at least one electronic device comprises the following steps:
comparing the plurality of network packet information of the plurality of network packets to calculate an occurrence frequency corresponding to the plurality of network packets; and
determining the plurality of first packet features corresponding to the at least one electronic device based on the occurrence frequency corresponding to the plurality of network packets.

14. The network management method of claim 11, wherein the step of determining the plurality of first packet features corresponding to the at least one electronic device comprises the following steps:
comparing the plurality of network packet information of the plurality of network packets to calculate an occurrence frequency and a packet time corresponding to the plurality of network packets; and
determining the plurality of first packet features corresponding to the at least one electronic device based on the occurrence frequency and the packet time corresponding to the plurality of network packets.

15. The network management method of claim 11, wherein the step of determining the plurality of first packet features corresponding to the at least one electronic device comprises the following steps:
comparing the plurality of network packet information of the plurality of network packets to calculate an occurrence frequency, a packet time, and a packet size corresponding to the plurality of network packets; and
determining the plurality of first packet features corresponding to the at least one electronic device based on the occurrence frequency, the packet time, and the packet size corresponding to the plurality of network packets.

16. The network management method of claim 11, wherein the network management method further comprises the following steps:
calculating a rule weight corresponding to each of the at least one first candidate rule;
determining at least one application rule from the at least one first candidate rule based on the rule weights; and
managing the plurality of network packets transmitted by the at least one electronic device on the network based on the at least one application rule.

17. The network management method of claim 16, wherein the step of managing the plurality of network packets transmitted by the at least one electronic device on the network comprises the following steps:
determining whether a network packet to be transmitted conforms to the at least one application rule; and
in response to the network packet to be transmitted conforming to the at least one application rule, allowing the at least one electronic device to transmit the network packet to be transmitted on the network.

18. The network management method of claim 11, wherein the network management method further comprises the following steps:
receiving a firewall log;
retrieving a plurality of second packet features corresponding to the at least one electronic device from the firewall log;
generating at least one second candidate rule corresponding to the at least one electronic device based on the plurality of second packet features; and
managing the plurality of network packets transmitted by the at least one electronic device on the network based on the at least one first candidate rule and the at least one second candidate rule.

19. The network management method of claim 18, wherein the network management device receives the firewall log from a network device, and the at least one electronic device is communicatively connected to the network device.

20. The network management method of claim 19, wherein the at least one electronic device transmits the plurality of network packets through the network device.
